(19) United States
(12) Patent Application Publication
(10) Pub. No.: US 2025/0272057 A1
(43) Pub. Date: Aug. 28, 2025

(54) DATA PROCESSING METHOD AND APPARATUS, ELECTRONIC DEVICE, STORAGE MEDIUM, AND PRODUCT

(71) Applicant: Beijing Volcano Engine Technology Co., Ltd., Beijing (CN)

(72) Inventors: Qizhi ZHANG, Beijing (CN); Daode Zhang, Beijing (CN); Quanwei Cai, Beijing (CN); Jue Hong, Beijing (CN); Ye Wu, Beijing (CN)

(21) Appl. No.: 18/963,109

(22) Filed: Nov. 27, 2024

(30) Foreign Application Priority Data
Feb. 22, 2024 (CN) 202410199683.1

(51) Int. Cl. G06F 7/24; G06F 17/16

(52) U.S. Cl. CPC G06F 7/24; G06F 17/16

(57) ABSTRACT

A data processing method and apparatus, an electronic device, a storage medium, and a product. Multiple shards of data of each datum in a data set are obtained; a first matrix is obtained according to the multiple shards of data; matrix operation is performed on the first matrix to obtain a second matrix; a shard data sorting result corresponding to the data set is obtained according to the first matrix and the second matrix; and the shard data sorting result is sent to a target party for determining a sorting result of data in the data set according to the shard data sorting result.

### CROSS-REFERENCE TO RELATED APPLICATION

The present disclosure is based on and claims the priority of Chinese Patent Application No. 202410199683.1, filed on Feb. 22, 2024, the disclosure of which is hereby incorporated into this disclosure by reference in its entirety.

### TECHNICAL FIELD

The present application relates to the field of computer technologies, and in particular, to a data processing method and apparatus, an electronic device, a storage medium, and a product.

### BACKGROUND

A user may perform data value mining through multi-party collaboration by means of a privacy computing service platform on the premise that private original data does not go out of a domain.

In some scenarios, it is usually necessary to perform joint analysis and processing on data of different data owner parties.

### SUMMARY

In a first aspect, the present application provides a data processing method, applied to a calculation party, where the method includes:
obtaining multiple shards of data of each datum in a data set, where the data set comes from a data owner party; obtaining a first matrix according to the multiple shards of data;
performing matrix operation on the first matrix to obtain a second matrix;
obtaining a shard data sorting result corresponding to the data set according to the first matrix and the second matrix; and
sending the shard data sorting result to a target party for determining a sorting result of data in the data set according to the shard data sorting result.

In a second aspect, the present application provides a data processing method, applied to a data owner party, where the method includes:
obtaining a data set;
encoding each datum in the data set into multiple vectors;
splitting the multiple vectors into multiple shards of data; and
sending the multiple shards of data to a calculation party for performing: obtaining a first matrix according to the multiple shards of data, performing matrix operation on the first matrix to obtain a second matrix, obtaining a shard data sorting result corresponding to the data set according to the first matrix and the second matrix, and sending the shard data sorting result to a target party for determining a sorting result of data in the data set according to the shard data sorting result.

In a third aspect, the present application provides a data processing apparatus, applied to a calculation party, where the apparatus includes:
a first obtaining module configured to obtain multiple shards of data of each datum in a data set, where the data set comes from a data owner party;
a first calculation module configured to obtain a first matrix according to the multiple shards of data;
a second calculation module configured to perform matrix operation on the first matrix to obtain a second matrix;
a third calculation module configured to obtain a shard data sorting result corresponding to the data set according to the first matrix and the second matrix; and
a first sending module configured to send the shard data sorting result to a target party for determining a sorting result of data in the data set according to the shard data sorting result.

In a fourth aspect, the present application provides a data processing apparatus, applied to a data owner party, where the apparatus includes:
a second obtaining module configured to obtain a data set;
an encoding module configured to encode each datum in the data set into multiple vectors;
a splitting module configured to split the multiple vectors into multiple shards of data; and
a second sending module configured to send the multiple shards of data to a calculation party for performing:
obtaining a first matrix according to the multiple shards of data, performing matrix operation on the first matrix to obtain a second matrix, obtaining a shard data sorting result corresponding to the data set according to the first matrix and the second matrix, and sending the shard data sorting result to a target party for determining a sorting result of data in the data set according to the shard data sorting result.

In a fifth aspect, the present application provides an electronic device, including a memory, a processor, and a computer program stored in the memory and executable on the processor, where the processor, when executing the program, performs the method according to the first aspect.

In a sixth aspect, the present application provides a non-transitory computer-readable storage medium, where the non-transitory computer-readable storage medium stores computer instructions, and the computer instructions are used to cause a computer to perform the method according to the first aspect.

In a seventh aspect, the present application provides a computer program product, including computer program instructions, where when the computer program instructions are executed on a computer, the computer is caused to perform the method according to the first aspect.

### BRIEF DESCRIPTION OF THE DRAWINGS

In order to more clearly illustrate the technical solutions in the present application or in the related art, the following briefly introduces the drawings required for describing the embodiments or the related art. Apparently, the drawings in the following description are merely embodiments of the present application, and for those of ordinary skill in the art, other drawings may also be obtained based on these drawings without creative efforts.

FIG. 1 shows a schematic diagram of an exemplary system according to an embodiment of the present application.

FIG. 2 shows a schematic diagram of an exemplary system according to an embodiment of the present application.

FIG. 3A shows a schematic diagram of an exemplary first shard matrix according to an embodiment of the present application.

FIG. 3B shows a schematic diagram of an exemplary second shard matrix according to an embodiment of the present application.

FIG. 4 shows a schematic diagram of an exemplary calculation party according to an embodiment of the present application.

FIG. 5 shows a schematic diagram of an exemplary system according to an embodiment of the present application.

FIG. 6A shows a schematic flowchart of an exemplary data processing method according to an embodiment of the present application.

FIG. 6B shows a schematic flowchart of an exemplary data processing method according to an embodiment of the present application.

FIG. 7A shows a schematic flowchart of an exemplary data processing apparatus according to an embodiment of the present application.

FIG. 7B shows a schematic flowchart of an exemplary data processing apparatus according to an embodiment of the present application.

FIG. 8 shows a schematic diagram of an exemplary electronic device according to an embodiment of the present application.

### DETAILED DESCRIPTION OF EMBODIMENTS

In order to make the objectives, technical solutions, and advantages of the present application clearer, the present application is further described in detail below with reference to the drawings and in conjunction with specific embodiments.

It should be noted that, unless otherwise defined, the technical terms or scientific terms used in the embodiments of the present application shall have the general meanings as understood by those of ordinary skill in the art to which the present application belongs. “First”, “second”, and similar words used in the embodiments of the present application do not indicate any order, quantity, or importance, but are only used to distinguish different components.

Words such as “include” or “comprise” mean that an element or object appearing in front of the word encompasses an element or object listed after the word and its equivalent, without excluding other elements or objects. Words such as “connected” or “linked” are not limited to physical or mechanical connections, but may include electrical connections, whether direct or indirect. “Up”, “down”, “left”, “right”, and the like are only used to indicate a relative positional relationship, and when an absolute position of a described object changes, the relative positional relationship may also change accordingly.

It can be understood that before using the technical solutions of the embodiments of the present application, a user will be informed of the type, scope of use, use scenario, and the like of involved personal information in an appropriate manner, and the user's authorization will be obtained.

For example, in response to receiving an active request from the user, prompt information is sent to the user to clearly prompt the user that an operation requested to be performed will require the acquisition and use of the user's personal information. Thereby, the user can independently choose, according to the prompt information, whether to provide personal information to software or hardware such as an electronic device, an application, a server, or a storage medium that performs the operation of the technical solution of the present application.

As an optional but non-limiting implementation, the manner of sending prompt information to the user in response to receiving the active request from the user may be, for example, a pop-up window, and the prompt information may be presented in text in the pop-up window. In addition, the pop-up window may also carry a selection control for the user to choose whether to “agree” or “disagree” to provide the personal information to the electronic device.

It can be understood that the above process of notifying and obtaining user authorization is only illustrative and does not limit the implementations of the present application, and other manners that satisfy relevant laws and regulations may also be applied to the implementations of the present application.

In a process of joint analysis and processing on multi-party data, a problem that needs to be solved urgently is how to reduce the communication volume in a process of multi-party collaboration on the premise of ensuring data privacy protection and security.

In view of this, the present application aims to provide a data processing method and apparatus, an electronic device, a storage medium, and a product to solve or partially solve the above problems.

Secure multi-party computation (MPC) is an algorithm for protecting data privacy and security. The multi-party secure computation enables a plurality of data holding participants to perform collaborative computation without data privacy leakage.

The multi-party secure computation includes a plurality of computation parties, and a plurality of data owner parties may send data owned by the parties to the plurality of computation parties, and the plurality of computation parties perform joint analysis and processing by using the multi-party data.

As described in the background section, in the process of joint analysis and processing on multi-party data, a problem that needs to be solved urgently is how to reduce the communication volume in the process of multi-party collaboration on the premise of ensuring data privacy protection and security.

In view of this, the present application provides a data processing method and apparatus, an electronic device, a storage medium, and a product. Multiple shards of data of each datum (data item) in a data set are obtained; a first matrix is obtained according to the multiple shards of data; matrix operation is performed on the first matrix to obtain a second matrix; a shard data sorting result corresponding to the data set is obtained according to the first matrix and the second matrix; and the shard data sorting result is sent to a target party, such that the target party determines a sorting result of data in the data set according to the shard data sorting result. By means of the method, on the premise of ensuring data privacy protection and security, a processing of shard data is implemented by means of one round of communication interaction between calculation parties, thereby reducing the communication volume in a process of calculation party collaboration.

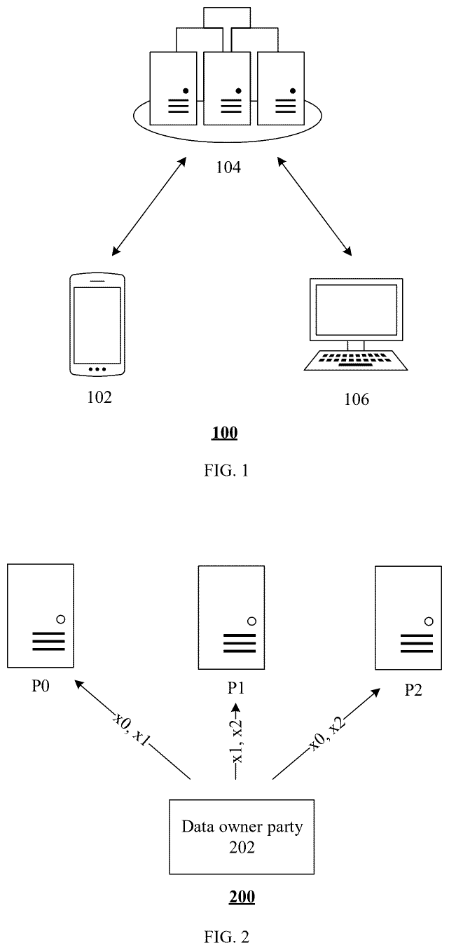

FIG. 1 shows a schematic diagram of an exemplary system 100 according to an embodiment of the present application.

As shown in FIG. 1, the system 100 may include multiple data owner parties, and a data owner party may be a terminal system including a terminal device, a server, and a database. Taking the system 100 including a first data owner party 102 and a second data owner party 106 as an example, the first data owner party 102 and the second data owner party 106 may be an individual, an enterprise, a university, a government, or other organizations or entities that maintain data, respectively. The first data owner party 102 and the second data owner party 106 are generally separated from each other and manage their data independently of each other.

The first data owner party 102, the second data owner party 106, or other target parties may expect to perform a joint analysis by using the data of the first data owner party 102 and the data of the second data owner party 106 (for example, sorting multiple data held by the data owner party), without revealing data of each data owner party to each other. The first data owner party 102 and the second data owner party 106 may send data held by them to a calculation party 104, and the calculation party 104 performs secure data calculation and returns a calculation result to the first data owner party 102, the second data owner party 106, or other target parties that expect to perform data analysis.

The calculation party 104 may be a privacy computing service platform including multiple servers, and performs data calculation on the premise that data privacy protection can be ensured.

FIG. 2 shows a schematic diagram of an exemplary system 200 according to an embodiment of the present application.

As shown in FIG. 2, in the system 200, the calculation party 104 may include a plurality of calculation parties, and the plurality of calculation parties may cooperate to perform secure data calculation. In some embodiments, the calculation party 104 may include three calculation parties (a first calculation party P₀, a second calculation party P₁, and a third calculation party P₂). In three-party secure computation, the data owner party 202 may send data to the three calculation parties, and the three calculation parties cooperate to perform secure data computation. It should be noted that the number of data owner parties 202 may be one or more, which is not limited in the present application.

One or more data owner parties 202 may hold a data set. One data owner party holds all n data items in the data set, and each of multiple data owner parties holds one data set, where each data set includes some of the n data items.

Taking one data owner party holding all n data items in the data set as an example, the n data items may be represented as a₁, . . . , aₙ∈ [symbol] /N [symbol] . Where [symbol] /N [symbol] represents a residue class ring. [symbol] /N [symbol] : ={0,1, . . . , N-1}, where addition is defined as integer addition mod N, and multiplication is defined as integer multiplication mod N. N represents a natural number. [symbol] represents an integer ring. A ring refers to a set, which is defined with two operations, i.e., addition and multiplication, the addition forms an Abelian group, elements other than 0 form a semigroup with respect to the multiplication, and the multiplication satisfies the distributive law with respect to the addition. For the integer ring [symbol] , the addition and multiplication are addition and multiplication in a general sense.

Taking the target party expecting to obtain the sorting result of the n data items in the data set as an example, in some embodiments, the data owner party 202 may encode each datum in the data set it owns into multiple vectors, and split the multiple vectors into multiple secret shards (multiple shards of data) and send them to the calculation party.

In some embodiments, the data owner party 202 may use a one-hot encoding technology to encode the data.

In the one-hot encoding, if a datum a has K possible values, the datum may be encoded with one-hot encoding, and the encoded vector One-Hot(x) is a K-dimensional vector, with the ath bit being 1 and other bits being 0 in the K-dimensional vector. The dimension K of the vector may be determined according to user requirements.

For example, taking encoding data as 5-dimensional vectors as an example, for data in [symbol] /5 [symbol] , the one-hot encoding result is as follows:
for data 0, it may be encoded as (1, 0, 0, 0, 0); for data 1, it may be encoded as (0, 1, 0, 0, 0); for data 2, it may be encoded as (0, 0, 1, 0, 0); for data 3, it may be encoded as (0, 0, 0, 1, 0); and for data 4, it may be encoded as (0, 0, 0, 0, 1).

The data owner party 202 may obtain n vectors after encoding the n data items in the data set. In some embodiments, the data owner party 202 may use a replicated secret sharing technology to secretly split each of the n vectors and send them to the calculation party.

In the replicated secret sharing technology, data x is stored in a first calculation party P₀, a second calculation party P₁, and a third calculation party P₂ in the form of secret shards, and the data x may be split into a first shard of data x₀, a second shard of data x₁, and a third shard of data x₂, where x=x₀+x₁+x₂, x₀, x₁, x₂∈R, where R represents a real number.

For the encoded vector in the embodiments of the present application, taking encoding data 2 as a 5-dimensional vector (0, 0, 1, 0, 0) as an example, the vector (0, 0, 1, 0, 0) may be split into a first shard of data (0, 0, 0.2, 0, 0), a second shard of data (0, 0, 0.4, 0, 0), and a third shard of data (0, 0, 0.4, 0, 0) by using the replicated secret sharing technology.

After splitting each of the n vectors, the data owner party 202 may obtain n first shards of data, n second shards of data, and n third shards of data. The data owner party 202 may send the split shards of data to the calculation party.

The calculation party Pᵢ holds xᵢ, x_{i+1 mod 3}, where the value of i may be 1, 2, or 3, and mod represents a remainder.

As shown in FIG. 2, in some embodiments, the first calculation party P₀ may hold the first shard of data x₀ and the second shard of data x₁; the second calculation party P₁ may hold the second shard of data x₁ and the third shard of data x₂; and the third calculation party P₂ may hold the first shard of data x₀ and the third shard of data x₂.

After receiving the multiple shards of data, each calculation party may, in some embodiments, use the multiple shards of data to form a matrix A (for example, the first matrix). The number of dimensions (the number of columns) of the matrix A is the same as the number of dimensions of the encoded vector of the data, and the number of rows of the matrix A is the same as the number of the n data items. Since the data owner party 202 holds a plurality of data items, a plurality of shards of data (for example, a plurality of first shards of data, a plurality of second shards of data, and a plurality of third shards of data) may be obtained after the plurality of data items are encoded and split. After the data owner party 202 sends the multiple shards of data to the calculation party, each calculation party may hold multiple shards of data respectively.

For example, the first calculation party P₀ may hold a plurality of first shards of data x₀ and a plurality of second shards of data x₁; the second calculation party P₁ may hold a plurality of second shards of data x₁ and a plurality of third shards of data x₂; and the third calculation party P₂ may hold a plurality of first shards of data x₀ and a plurality of third shards of data x₂.

Taking the multiple first shards of data x₀ and the multiple second shards of data x₁ held by the first calculation party P₀ as an example, the first calculation party P₀ may hold 6 first shards of data and 6 second shards of data. In some embodiments, the first calculation party P₀ may use the multiple first shards of data to form a first shard matrix, and use the multiple second shards of data to form a second shard matrix.

For example, the 6 first shards of data may be 6 vectors (0, 0, 0.2, 0, 0), (0, 0.2, 0, 0, 0), (0.2, 0, 0, 0, 0), (0, 0, 0, 0, 0.2), (0, 0, 0, 0.2, 0), (0, 0, 0.2, 0, 0), and the first shard matrix formed thereby may be as follows:
(0, 0, 0.2, 0, 0)
(0, 0.2, 0, 0, 0)
(0.2, 0, 0, 0, 0)
(0, 0, 0, 0, 0.2)
(0, 0, 0, 0.2, 0)
(0, 0, 0.2, 0, 0).

The 6 second shards of data may be 6 vectors (0, 0, 0.4, 0, 0), (0, 0.4, 0, 0, 0), (0.4, 0, 0, 0, 0), (0, 0, 0, 0, 0.4), (0, 0, 0, 0.4, 0), (0, 0, 0.4, 0, 0), and the second shard matrix formed thereby may be as follows:
(0, 0, 0.4, 0, 0)
(0, 0.4, 0, 0, 0)
(0.4, 0, 0, 0, 0)
(0, 0, 0, 0, 0.4)
(0, 0, 0, 0.4, 0)
(0, 0, 0.4, 0, 0).

The first calculation party Po may perform matrix operation on the matrix A to obtain the matrix B (for example, the second matrix). In some embodiments, the first calculation party P₀ may perform column-major accumulation on the elements in the matrix A.

For example, the first calculation party P₀ uses the first element in the first column of the matrix A as the first element in the first column of the matrix B, adds the first element and the second element in the first column of the matrix A, and uses the obtained numerical value as the second element in the first column of the matrix B, and so on.

After the elements in the first column of the matrix A are accumulated, the numerical value obtained by accumulating the first column of the matrix A is added to the first element in the second column of the matrix A, and the obtained numerical value is used as the first element in the second column of the matrix B.

For the first shard matrix and the second shard matrix, in some embodiments, the first calculation party P₀ may perform matrix operation on the first shard matrix to obtain a third shard matrix, and perform matrix operation on the second shard matrix to obtain a fourth shard matrix.

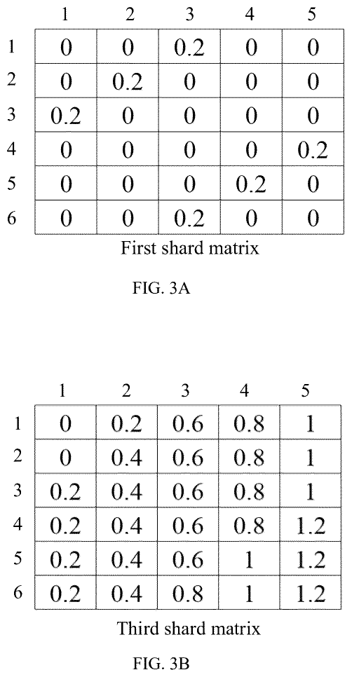

FIG. 3A shows a schematic diagram of an exemplary first shard matrix according to an embodiment of the present application. FIG. 3B shows a schematic diagram of an exemplary second shard matrix according to an embodiment of the present application.

With reference to FIG. 3A and FIG. 3B, in some embodiments, when the first calculation party P₀ performs column-major accumulation on the elements in the first shard matrix, a first element 0 in a first column in the first shard matrix may be used as a first element 0 in a first column in the third shard matrix. A first element 0 and a second element 0 in the first column in the first shard matrix are added to obtain a first accumulation numerical value 0. The numerical value 0 is used as a second element 0 in the first column in the third shard matrix. A third element 0.2 in the first column in the first shard matrix is added to the first accumulation numerical value 0 to obtain a second accumulation numerical value 0.2. The second accumulation numerical value 0.2 is used as a third element 0.2 in the first column in the third shard matrix. By analogy.

Therefore, a third accumulation numerical value 0.2 may be obtained by accumulating the first column of the first shard matrix to a sixth element. The third accumulation numerical value 0.2 is used as a sixth element 0.2 in the first column of the third shard matrix.

After the elements in the first column of the first shard matrix are accumulated, the third accumulation numerical value 0.2 obtained by accumulation is added to a first element 0 in a second column of the first shard matrix, to obtain a fourth accumulation numerical value 0.2. The fourth accumulation numerical value 0.2 is used as a first element 0.2 in the second column of the third shard matrix. A second element 0.2 in the second column of the first shard matrix is added to the fourth accumulation numerical value 0.2 to obtain a fifth accumulation numerical value 0.4. The fifth accumulation numerical value 0.4 is used as a second element 0.4 in the second column of the third shard matrix. By analogy.

Therefore, a sixth accumulation numerical value 0.4 may be obtained by accumulating the second column of the first shard matrix to a sixth element. The sixth accumulation numerical value 0.4 is used as a sixth element 0.4 in the second column of the third shard matrix.

After the elements in the second column of the first shard matrix are accumulated, the sixth accumulation numerical value 0.4 obtained by accumulation is added to a first element 0.2 in a third column of the first shard matrix, to obtain a seventh accumulation numerical value 0.6. The seventh accumulation numerical value 0.6 is used as a first element 0.6 in the third column of the third shard matrix. A second element 0 in the third column of the first shard matrix is added to the seventh accumulation numerical value 0.6 to obtain an eighth accumulation numerical value 0.6. The eighth accumulation numerical value 0.6 is used as a second element 0.6 in the third column of the third shard matrix.

By analogy.

Therefore, a ninth accumulation numerical value 0.8 may be obtained by accumulating the third column of the first shard matrix to a sixth element. The ninth accumulation numerical value 0.8 is used as a sixth element 0.8 in the third column of the third shard matrix.

After the elements in the third column of the first shard matrix are accumulated, the ninth accumulation numerical value 0.8 obtained by accumulation is added to a first element 0 in a fourth column of the first shard matrix, to obtain a tenth accumulation numerical value 0.8. The tenth accumulation numerical value 0.8 is used as a first element 0.8 in the fourth column of the third shard matrix. A second element 0 in the fourth column of the first shard matrix is added to the tenth accumulation numerical value 0.8 to obtain an eleventh accumulation numerical value 0.8. The eleventh accumulation numerical value 0.8 is used as a second element 0.8 in the fourth column of the third shard matrix. By analogy.

Therefore, a twelfth accumulation numerical value 1 may be obtained by accumulating the fourth column of the first shard matrix to a sixth element. The twelfth accumulation numerical value 1 is used as a sixth element 1 in the fourth column of the third shard matrix.

After the elements in the fourth column of the first shard matrix are accumulated, the twelfth accumulation numerical value 1 obtained by accumulation is added to a first element 0 in a fifth column of the first shard matrix, to obtain a thirteenth accumulation numerical value 1. The thirteenth accumulation numerical value 1 is used as a first element 1 in the fifth column of the third shard matrix. A second element 0 in the fifth column of the first shard matrix is added to the thirteenth accumulation numerical value 1 to obtain a fourteenth accumulation numerical value 1. The fourteenth accumulation numerical value 1 is used as a second element 1 in the fifth column of the third shard matrix.

By analogy.

Therefore, a fifteenth accumulation numerical value 1.2 may be obtained by accumulating the fifth column of the first shard matrix to a sixth element. The fifteenth accumulation numerical value 1.2 is used as a sixth element 1.2 in the fifth column of the third shard matrix.

It should be noted that in the above embodiments, the matrix operation on the first shard matrix to obtain the third shard matrix is only used as an example to describe the matrix operation method. The matrix operation method for performing matrix operation on the second shard matrix to obtain the fourth shard matrix and performing matrix operation on the first matrix to obtain the second matrix is the same as the matrix operation method in the above embodiments, and details are not repeated in the present application.

After the matrix B is obtained through matrix operation, in some embodiments, the calculation party may obtain the sorting result of the n data items according to the matrix A and the matrix B.

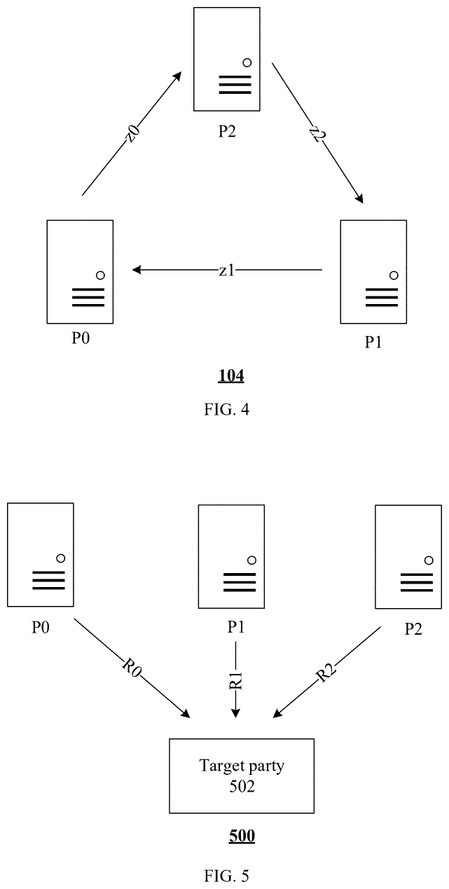

FIG. 4 shows a schematic diagram of an exemplary calculation party 104 according to an embodiment of the present application.

The calculation party 104 may perform addition and multiplication based on the replicated secret sharing technology.

The addition based on the replicated secret sharing technology may be implemented by adding the shards held by each calculation party correspondingly.

In some embodiments, after the first calculation party P₀ performs matrix operation to obtain the matrix B, an inner product of the matrix A and the matrix B may be performed row by row, so as to obtain the shard data sorting result corresponding to the n data items.

For example, the first calculation party P₀ may multiply each element in the first row of the matrix A by each element in the first row of the matrix B respectively, and then add results of the multiplying each element, so as to obtain the shard data sorting result corresponding to the n data items.

For the first shard matrix and the second shard matrix in the first calculation party P₀, in some embodiments, after the first calculation party P₀ performs matrix operation to obtain the third shard matrix and the fourth shard matrix, the shard data sorting result may be obtained according to the first shard matrix, the second shard matrix, the third shard matrix, and the fourth shard matrix.

For the row-by-row inner product operation of the first shard matrix, the second shard matrix, the third shard matrix, and the fourth shard matrix, in some embodiments, multiplication of the first calculation party P₀ based on the replicated secret sharing technology may be calculated by using the following protocol.
Step 1: the calculation party Pᵢ calculates the shard data sorting result uᵢ:=xᵢyᵢ+xᵢy_{(i+1 mod 3 )}+x_{(i+1 mod 3)}yᵢ, where x and y may respectively represent shard matrices held in each calculation party.

Taking the row-by-row inner product operation in the first calculation party P₀ as an example, in some embodiments, the first calculation party P₀ may calculate the shard data sorting result u₀:=x₀y₀+x₀y₁+x₁y ₀ where x₀ may be the first shard matrix, y₀ may be the second shard matrix, x₁ may be the second shard matrix, and y₁ may be the fourth shard matrix.
Step 2: the calculation party Pᵢ generates a random number rᵢ that satisfies r+r₁+r₂=0.

Taking the first calculation party P₀ as an example, in some embodiments, the first calculation party P₀ may generate the random number r₀.
Step 3: the calculation party Pᵢ calculates zᵢ:=uᵢ+rᵢ.

Taking the first calculation party P₀ as an example, in some embodiments, the first calculation party P₀ may calculate a numerical value z₀ obtained by adding the shard data sorting result u₀ and the random number r₀.
Step 4: the calculation party Pᵢ sends zᵢ to P_{(i-1 mod 3)}.

Taking the first calculation party P₀ as an example, as shown in FIG. 4, in some embodiments, the first calculation party P₀ may send the numerical value z₀ to the second calculation party P₂. In some embodiments, the second calculation party P₂ may send the calculation result z₂ to the third calculation party P₁. The third calculation party P₁ may send the calculation result z₁ to the first calculation party P₀.

It should be noted that in the above embodiments, the multiplication in the calculation process may be scalar multiplication, vector multiplication, vector inner product, polynomial multiplication, matrix multiplication, and the like. Different calculation methods adopted for different forms (for example, matrix or vector) of corresponding variables should fall within the protection scope of the present application.

FIG. 5 shows a schematic diagram of an exemplary system 500 according to an embodiment of the present application. Since each calculation party receives the shards of data sent from the data owner party 202, the sorting result calculated by each calculation party is the shard data sorting result Rᵢ. As shown in FIG. 5, in some embodiments, each calculation party may send the shard data sorting result Rᵢ it owns to the target party 502, so that the user can obtain the sorting result R of the n data that the target party 502 wants to view based on the multiple shard data sorting results. The target party 502 may be the data owner party 202 or other target parties 502.

For example, the first calculation party P₀ may send the owned shard data sorting result R₀ to the target party 502.

The second calculation party P₁ may send the owned shard data sorting result R₁ to the target party 502. The third calculation party P₂ may send the owned shard data sorting result R₂ to the target party 502. After receiving the shard data sorting results from the three parties, the target party 502 can obtain the sorting result R of the n data according to R=R₀+R₁+R₂.

In this way, in the process of data processing, since the data owner party needs to send the shards of data to multiple calculation parties after encoding and splitting the multiple data items it holds into the shards of data. In the communication volume generated in this round of communication interaction, the communication volume of each calculation party is: 2nKlog|R|. Where R represents a ring. After each calculation party calculates the shard data sorting result, the shard data sorting result is sent to the target party. In the communication volume generated in this round of communication interaction, the communication volume of each calculation party is: nlog|R|. In the process of sending the random number rᵢ and the shard data sorting result uᵢ between multiple calculation parties, in the communication volume generated in this round of communication interaction, the communication volume of each calculation party is: nlog|R|. It can be seen that the method provided by the embodiments of the present application can implement the processing of the shards of data for multi-party collaboration at the cost of one round of communication. Data processing for multi-party collaboration can be implemented at the cost of a constant round of communication. In this way, on the premise of ensuring data privacy protection and security, data processing for multi-party collaboration is implemented with a lower communication volume.

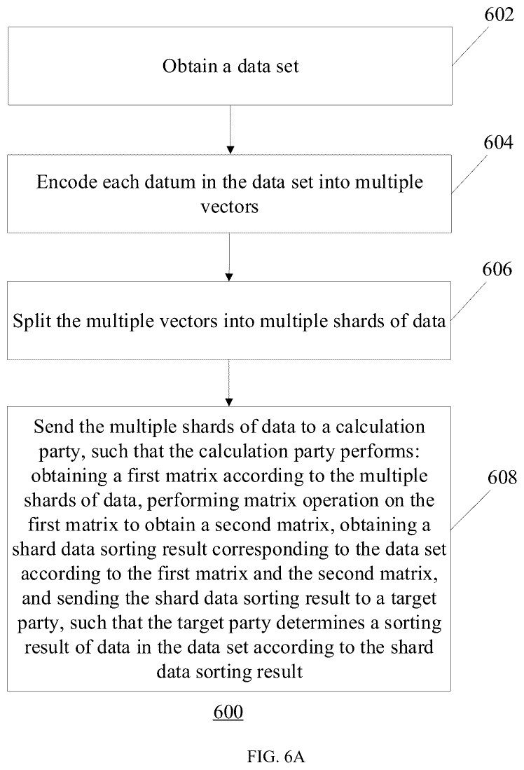

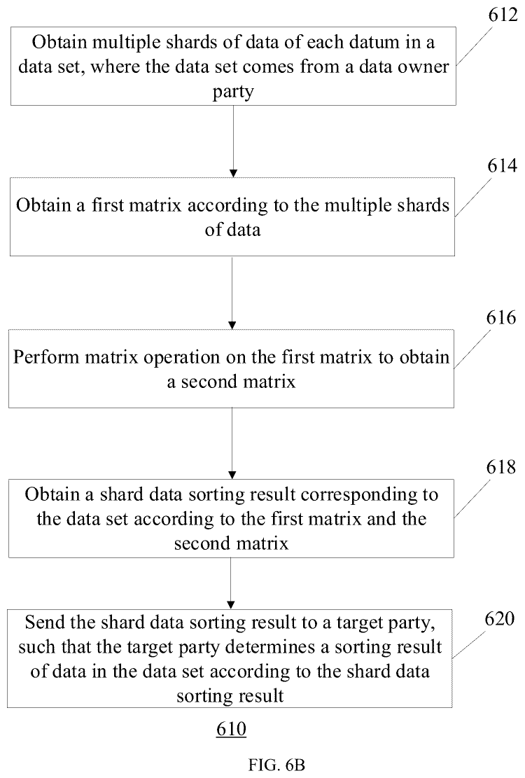

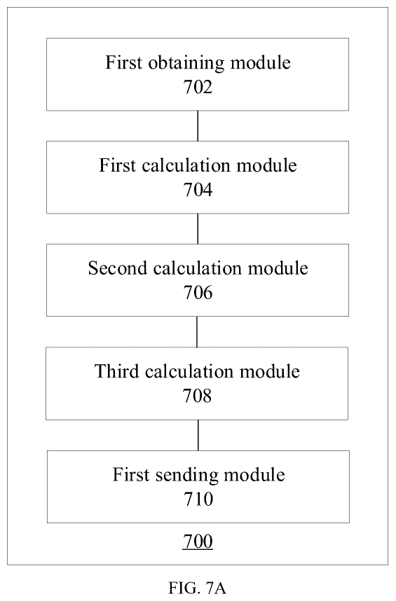

FIG. 6A shows a schematic flowchart of an exemplary data processing method 600 according to an embodiment of the present application. The method 600 may be implemented by the system 100 (for example, the system 100 in FIG. 1). More specifically, the method 600 may be performed by a data owner party in the system 100 (for example, the data owner party 202 in FIG. 2). The method 600 may include the following steps.

In step 602, a data set is obtained.

In step 604, each datum in the data set is encoded into multiple vectors.

In some embodiments, the encoding the each datum in the data set into the multiple vectors further includes: determining a number of dimensions (for example, K-dimensional) of the vector, where the number of dimension is greater than or equal to a value of the datum; encoding, according to the datum, an element at a position in the vector corresponding to the datum as a fourth numerical value; encoding an element at a position other than the position corresponding to the datum in the vector as a fifth numerical value; and obtaining the vector according to the fourth numerical value and the fifth numerical value.

In step 606, the multiple vectors are split into multiple shards of data (for example, a first shard of data x₀, a second shard of data x₁, and a third shard of data x₂).

In some embodiments, the splitting the multiple vectors into the multiple shards of data further includes: splitting the vector into multiple shard vectors such that a sum of the multiple shard vectors is equal to the vector (for example, x=x₀+x₁+x₂); and using the shard vector as the shard data.

In step 608, the multiple shards of data are sent to a calculation party (for example, the first calculation party P₀, the second calculation party P₁, and the third calculation party P₂ in FIG. 2), so that the calculation party performs:

obtaining a first matrix (for example, the matrix A) according to the multiple shards of data, performing matrix operation on the first matrix to obtain a second matrix (for example, the matrix B), obtaining a shard data sorting result corresponding to the data set according to the first matrix and the second matrix, and sending the shard data sorting result to a target party (for example, the target party 502 in FIG. 5), so that the target party determines a sorting result of data in the data set according to the shard data sorting result.

The present application provides a data processing method and apparatus, an electronic device, a storage medium, and a product. Multiple shards of data of each datum in a data set are obtained; a first matrix is obtained according to the multiple shards of data; matrix operation is performed on the first matrix to obtain a second matrix; a shard data sorting result corresponding to the data set is obtained according to the first matrix and the second matrix; and the shard data sorting result is sent to a target party, such that the target party determines a sorting result of data in the data set according to the shard data sorting result. By means of the method, on the premise of ensuring data privacy protection and security, a processing of shard data is implemented by means of one round of communication interaction between calculation parties, thereby reducing the communication volume in a process of calculation party collaboration.

FIG. 6B shows a schematic flowchart of an exemplary data processing method 610 according to an embodiment of the present application. The method 610 may be implemented by the system 100 (for example, the system 100 in FIG. 1). More specifically, the method 610 may be performed by the calculation party 104 in the system 100 (for example, any calculation party in the calculation party 104 in FIG. 1; or, the first calculation party P₀, the second calculation party P₁, or the third calculation party P₂ in FIG. 2). The method 600 may include the following steps.

In step 612, multiple shards of data of each datum in a data set are obtained, where the data set comes from a data owner party (for example, the data owner party 202 in FIG. 2).

In step 614, a first matrix (for example, the matrix A) is obtained according to the multiple shards of data (for example, the first shard of data x₀, the second shard of data x₁, and the third shard of data x₂).

In some embodiments, the multiple shards of data include multiple first shards of data and multiple second shards of data, the first matrix includes a first shard matrix and a second shard matrix, and the obtaining the first matrix according to the multiple shards of data further includes: obtaining the first shard matrix according to the multiple first shards of data; and obtaining the second shard matrix according to the multiple second shards of data.

In step 616, matrix operation is performed on the first matrix to obtain a second matrix (for example, the matrix B).

In some embodiments, the second matrix includes a third shard matrix and a fourth shard matrix, and the performing the matrix operation on the first matrix to obtain the second matrix further includes: performing the matrix operation on the first shard matrix to obtain the third shard matrix; and performing the matrix operation on the second shard matrix to obtain the fourth shard matrix.

In some embodiments, the performing the matrix operation on the first matrix to obtain the second matrix further includes: accumulating elements of the first matrix in a column direction so as to obtain the second matrix.

In some embodiments, the accumulating the elements of the first matrix in the column direction so as to obtain the second matrix further includes: using a first element in a first column of the first matrix as a first element in a first column of the second matrix; adding the first element and a second element in the first column of the first matrix to obtain a first numerical value; and using the first numerical value as a second element in the first column of the second matrix.

In some embodiments, the accumulating the elements of the first matrix in the column direction so as to obtain the second matrix further includes: accumulating elements in the first column of the first matrix to obtain a second numerical value; adding the second numerical value and a first element in a second column of the first matrix to obtain a third numerical value; and using the third numerical value as a first element in the second column of the second matrix.

In step 618, a shard data sorting result corresponding to the data set is obtained according to the first matrix and the second matrix.

In some embodiments, the obtaining the shard data sorting result corresponding to the data set according to the first matrix and the second matrix further includes: obtaining the shard data sorting result according to the first shard matrix, the second shard matrix, the third shard matrix, and the fourth shard matrix.

In some embodiments, the obtaining the shard data sorting result corresponding to the data set according to the first matrix and the second matrix further includes: performing inner product on the first matrix and the second matrix row by row to obtain the shard data sorting result corresponding to the data set.

In some embodiments, the performing inner product on the first matrix and the second matrix row by row to obtain the shard data sorting result corresponding to the data set further includes: multiplying the first shard matrix by the third shard matrix to obtain a first numerical value; multiplying the first shard matrix by the fourth shard matrix to obtain a second numerical value; multiplying the second shard matrix by the third shard matrix to obtain a third numerical value; and adding the first numerical value, the second numerical value, and the third numerical value to obtain the shard data sorting result (for example, the shard data sorting result uᵢ).

In step 620, the shard data sorting result is sent to a target party (for example, the target party 502 in FIG. 5), so that the target party determines the sorting result of the data in the data set (for example, the sorting result R of the n data items) according to the shard data sorting result.

In some embodiments, the sending the shard data sorting result to the target party further includes: generating a random number (for example, the random number rᵢ), and sending the random number and the shard data sorting result to the target party.

The present application provides a data processing method and apparatus, an electronic device, a storage medium, and a product. Multiple shards of data of each datum in a data set are obtained; a first matrix is obtained according to the multiple shards of data; matrix operation is performed on the first matrix to obtain a second matrix; a shard data sorting result corresponding to the data set is obtained according to the first matrix and the second matrix; and the shard data sorting result is sent to a target party, such that the target party determines a sorting result of data in the data set according to the shard data sorting result. By means of the method, on the premise of ensuring data privacy protection and security, a processing of shard data is implemented by means of one round of communication interaction between calculation parties, thereby reducing the communication volume in a process of calculation party collaboration.

It should be noted that the method of the embodiments of the present application may be performed by a single device, such as a computer or a server. The method of the embodiments may also be applied to a distributed scenario and completed by multiple devices in cooperation. In this distributed scenario, one of the multiple devices may only perform one or more steps in the method of the embodiments of the present application, and the multiple devices may interact with each other to complete the method.

It should be noted that some embodiments of the present application have been described above. Other embodiments are within the scope of the appended claims. In some cases, the actions or steps recited in the claims may be performed in a different order from that in the above embodiments, and desired results may still be achieved. In addition, the processes depicted in the drawings do not necessarily require the specific order or consecutive order shown to achieve the desired results. In some implementations, multitasking and parallel processing are also possible or may be advantageous.

Based on the same technical concept, corresponding to the method of any of the above embodiments, the present application further provides a data processing apparatus 700.

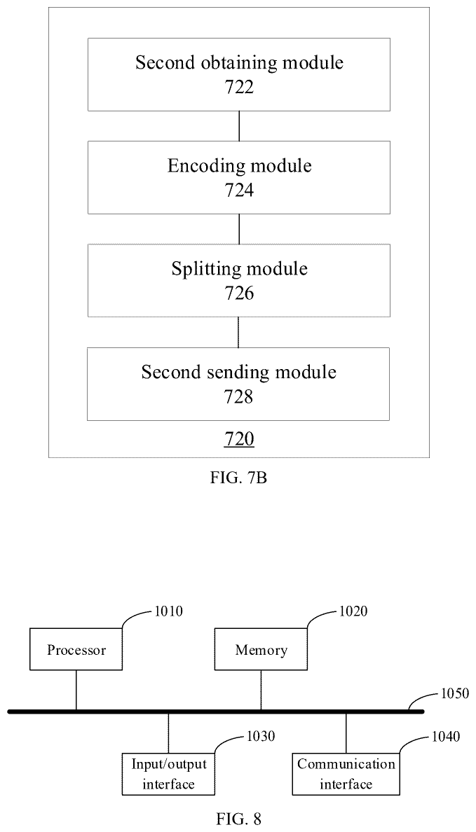

With reference to FIG. 7A, the apparatus 700 may include:
a first obtaining module 702 configured to obtain multiple shards of data of each datum in a data set, where the data set comes from a data owner party;
a first calculation module 704 configured to obtain a first matrix according to the multiple shards of data;
the first calculation module 704 is further configured to obtain the first shard matrix according to the multiple first shards of data; and obtain the second shard matrix according to the multiple second shards of data;
a second calculation module 706 configured to perform matrix operation on the first matrix to obtain a second matrix; the second calculation module 706 is further configured to perform matrix operation on the first shard matrix to obtain a third shard matrix; and perform matrix operation on the second shard matrix to obtain a fourth shard matrix;
the second calculation module 706 is further configured to accumulate elements of the first matrix in a column direction so as to obtain the second matrix;
the second calculation module 706 is further configured to use a first element in a first column of the first matrix as a first element in a first column of the second matrix; add the first element and a second element in the first column of the first matrix to obtain a first numerical value; and use the first numerical value as a second element in the first column of the second matrix;
the second calculation module 706 is further configured to accumulate elements in the first column of the first matrix to obtain a second numerical value; add the second numerical value and a first element in a second column of the first matrix to obtain a third numerical value; and use the third numerical value as a first element in the second column of the second matrix; and
a third calculation module 708 configured to obtain a shard data sorting result corresponding to the data set according to the first matrix and the second matrix.

The third calculation module 708 is further configured to obtain the shard data sorting result according to the first shard matrix, the second shard matrix, the third shard matrix, and the fourth shard matrix.

The third calculation module 708 is further configured to perform inner product on the first matrix and the second matrix row by row, so as to obtain the shard data sorting result corresponding to the data set.

The third calculation module 708 is further configured to multiply the first shard matrix by the third shard matrix to obtain a first numerical value; multiply the first shard matrix by the fourth shard matrix to obtain a second numerical value; multiply the second shard matrix by the third shard matrix to obtain a third numerical value; and add the first numerical value, the second numerical value, and the third numerical value to obtain the shard data sorting result.

The first sending module 710 is configured to send the shard data sorting result to a target party, so that the target party determines the sorting result of the data in the data set according to the shard data sorting result.

The first sending module 710 is further configured to generate a random number and send the random number and the shard data sorting result to the target party.

For the convenience of description, when the above apparatus is described, various modules are described separately according to functions. Certainly, when implementing the present application, the functions of the modules may be implemented in the same piece of software or hardware or in multiple pieces of software or hardware.

The apparatus of the above embodiment is configured to implement the corresponding method 610 in any of the above embodiments, and has the beneficial effects of the corresponding method embodiment, which are not repeated herein.

Based on the same technical concept, corresponding to the method of any of the above embodiments, the present application further provides a data processing apparatus 720.

With reference to FIG. 7B, the apparatus 720 may include:
a second obtaining module 722 configured to obtain a data set;
an encoding module 724 configured to encode each datum in the data set into multiple vectors;
the encoding module 724 is further configured to determine a number of dimensions of the vector, where the number of dimensions is greater than or equal to a value of the datum; encode, according to the datum, an element at a position in the vector corresponding to the datum as a fourth numerical value; encode an element at a position other than the position corresponding to the datum in the vector as a fifth numerical value; and obtain the vector according to the fourth numerical value and the fifth numerical value;
a splitting module 726 configured to split the multiple vectors into multiple shards of data,
wherein the splitting module 726 is further configured to split the vector into multiple shard vectors such that a sum of the multiple shard vectors is equal to the vector; and use the shard vector as the shard data; and
a second sending module 728 configured to send the multiple shards of data to a calculation party, so that the calculation party performs: obtaining a first matrix according to the multiple shards of data, performing matrix operation on the first matrix to obtain a second matrix, obtaining a shard data sorting result corresponding to the data set according to the first matrix and the second matrix, and sending the shard data sorting result to a target party, so that the target party determines a sorting result of data in the data set according to the shard data sorting result.

For the convenience of description, when the above apparatus is described, various modules are described separately according to functions. Certainly, when implementing the present application, the functions of the modules may be implemented in the same piece of software or hardware or in multiple pieces of software or hardware.

The apparatus of the above embodiment is configured to implement the corresponding method 600 in any of the above embodiments, and has the beneficial effects of the corresponding method embodiment, which are not repeated herein.

Based on the same technical concept, corresponding to the method of any of the above embodiments, the present application further provides an electronic device, including a memory, a processor, and a computer program stored in the memory and executable on the processor, where the processor, when executing the program, performs the method 600 or the method 610 according to any of the above embodiments.

FIG. 8 shows a schematic diagram of an exemplary electronic device according to an embodiment of the present application. The device may include: a processor 1010, a memory 1020, an input/output interface 1030, a communication interface 1040, and a bus 1050. The processor 1010, the memory 1020, the input/output interface 1030, and the communication interface 1040 communicate with each other inside the device through the bus 1050.

The processor 1010 may be implemented by means of a general-purpose Central Processing Unit (CPU), a microprocessor, an Application Specific Integrated Circuit (ASIC), or one or more integrated circuits, and is configured to execute related programs to implement the technical solutions provided by the embodiments of the present description.

The memory 1020 may be implemented in the form of a Read Only Memory (ROM), a Random Access Memory (RAM), a static storage device, a dynamic storage device, or the like. The memory 1020 may store an operating system and other applications. When the technical solutions provided by the embodiments of the present description are implemented by means of software or firmware, related program codes are stored in the memory 1020 and invoked by the processor 1010 for execution.

The input/output interface 1030 is configured to connect to input/output modules to implement information input and output. The input/output modules may be configured as components in the device (not shown in the figure) or may be externally connected to the device to provide corresponding functions. The input device may include a keyboard, a mouse, a touchscreen, a microphone, various sensors, and the like, and the output device may include a display, a speaker, a vibrator, an indicator, and the like.

The communication interface 1040 is configured to connect to a communication module (not shown in the figure) to implement communication interaction between the device and other devices. The communication module may implement communication in a wired manner (for example, via a USB or a network cable) or in a wireless manner (for example, via a mobile network, WIFI, or Bluetooth).

The bus 1050 includes a path for transmitting information between components of the device (for example, the processor 1010, the memory 1020, the input/output interface 1030, and the communication interface 1040).

It should be noted that although the above device only shows the processor 1010, the memory 1020, the input/output interface 1030, the communication interface 1040, and the bus 1050, in a specific implementation process, the device may also include other components necessary for normal operation. In addition, those skilled in the art may understand that the above device may also include only components necessary for implementing the solutions of the embodiments of the present description, without necessarily including all of the components shown in the figure. The electronic device of the above embodiment is configured to implement the corresponding method 600 or method 610 in any of the above embodiments, and has the beneficial effects of the corresponding method embodiment, which are not repeated herein.

Based on the same technical concept, corresponding to the method of any of the above embodiments, the present application further provides a non-transitory computer-readable storage medium. The non-transitory computer-readable storage medium stores computer instructions, and the computer instructions are used to cause a computer to perform the method 600 or method 610 according to any of the above embodiments.

The computer-readable medium in this embodiment includes permanent and non-permanent, and movable and non-movable media, and information storage may be implemented by any method or technology. The information may be computer-readable instructions, data structures, program modules, or other data. Examples of computer storage media include, but are not limited to, phase change memory (PRAM), static random access memory (SRAM), dynamic random access memory (DRAM), other types of random access memory (RAM), read-only memory (ROM), electrically erasable programmable read-only memory (EEPROM), flash memory or other memory technologies, compact disc read-only memory (CD-ROM), digital versatile disc (DVD) or other optical storage, magnetic cassette, magnetic tape disk storage or other magnetic storage devices, or any other non-transmission media, which may be used to store information accessible to a computing device.

The computer instructions stored in the storage medium of the above embodiment are used to cause the computer to perform the method 600 or method 610 according to any of the above embodiments, and have the beneficial effects of the corresponding method embodiment, which are not repeated here.

Based on the same inventive concept, corresponding to the method 600 or method 610 according to any of the above embodiments, the present application further provides a computer program product, including computer program instructions, where when the computer program instructions are executed on a computer, the computer is caused to perform the method 600 or method 610 according to any of the above embodiments. In some embodiments, the computer program instructions may be executed by one or more processors of the computer to cause the computer and/or the processor to execute the method 600 or method 610. Corresponding to the execution subject corresponding to each step in each embodiment of the method 600 or method 610, the processor that executes the corresponding step may belong to the corresponding execution subject.

The computer program product of the above embodiment is used to cause the computer and/or the processor to execute the method 600 or method 610 according to any of the above embodiments, and has the beneficial effects of the corresponding method embodiment, which are not repeated here.

Those of ordinary skill in the art should understand that the discussion of any of the above embodiments is exemplary, and is not intended to imply that the scope of the present application (including the claims) is limited to these examples. Under the concept of the present application, the technical features in the above embodiments or different embodiments may also be combined, the steps may be implemented in any order, and there are many other changes in different aspects of the embodiments of the present application as described above, which are not provided in detail for the sake of brevity.

In addition, in order to simplify the description and discussion, and to avoid making the embodiments of the present application difficult to understand, the well-known power/ground connections to integrated circuit (IC) chips and other components may or may not be shown in the provided drawings. Furthermore, the apparatus may be shown in the form of a block diagram, so as to avoid making the embodiments of the present application difficult to understand, and this also takes into account the fact that the details of the implementations of these block diagrams are highly dependent on the platform on which the embodiments of the present application are to be implemented (i.e., these details should be completely within the understanding of those skilled in the art). In the case where specific details (e.g., circuits) are set forth to describe exemplary embodiments of the present application, it is obvious to those skilled in the art that the embodiments of the present application may be implemented without these specific details or with changes in these specific details. Therefore, these descriptions should be considered illustrative rather than restrictive.

Although the present application has been described in conjunction with specific embodiments of the present application, many substitutions, modifications, and variations of these embodiments will be apparent to those of ordinary skill in the art from the foregoing description. For example, other memory architectures (e.g., dynamic RAM (DRAM)) may use the discussed embodiments.

The embodiments of the present application are intended to cover all such substitutions, modifications, and variations that fall within the broad scope of the appended claims. Therefore, any omission, modification, equivalent replacement, improvement, etc. made within the spirit and principles of the embodiments of the present application shall be included in the protection scope of the present application.

What is claimed is:

1. A data processing method, applied to a calculation party, wherein the method comprises:
obtaining multiple shards of data of each datum in a data set, wherein the data set comes from a data owner party;
obtaining a first matrix according to the multiple shards of data;
performing matrix operation on the first matrix to obtain a second matrix;
obtaining a shard data sorting result corresponding to the data set according to the first matrix and the second matrix; and
sending the shard data sorting result to a target party for determining a sorting result of data in the data set according to the shard data sorting result.

2. The method according to claim 1, wherein the multiple shards of data comprise multiple first shards of data and multiple second shards of data, the first matrix comprises a first shard matrix and a second shard matrix, and the
obtaining the first matrix according to the multiple shards of data further comprises:
obtaining the first shard matrix according to the multiple first shards of data; and
obtaining the second shard matrix according to the multiple second shards of data.

3. The method according to claim 2, wherein the second matrix comprises a third shard matrix and a fourth shard matrix, and the performing matrix operation on the first matrix to obtain a second matrix further comprises:
performing matrix operation on the first shard matrix to obtain the third shard matrix; and
performing matrix operation on the second shard matrix to obtain the fourth shard matrix.

4. The method according to claim 3, wherein the obtaining a shard data sorting result corresponding to the data set according to the first matrix and the second matrix further comprises:
obtaining the shard data sorting result according to the first shard matrix, the second shard matrix, the third shard matrix, and the fourth shard matrix.

5. The method according to claim 1, wherein the performing matrix operation on the first matrix to obtain the second matrix further comprises:
accumulating elements of the first matrix in a column direction so as to obtain the second matrix.

6. The method according to claim 5, wherein the accumulating the elements of the first matrix in the column direction so as to obtain the second matrix further comprises:
using a first element in a first column of the first matrix as a first element in a first column of the second matrix;
adding the first element and a second element in the first column of the first matrix to obtain a first numerical value; and
using the first numerical value as a second element in the first column of the second matrix.

7. The method according to claim 6, wherein the accumulating the elements of the first matrix in the column direction so as to obtain the second matrix further comprises:
accumulating the elements in the first column of the first matrix to obtain a second numerical value;
adding the second numerical value and a first element in a second column of the first matrix to obtain a third numerical value; and
using the third numerical value as a first element in the second column of the second matrix.

8. The method according to claim 4, wherein the obtaining the shard data sorting result corresponding to the data set according to the first matrix and the second matrix further comprises:
performing inner product on the first matrix and the second matrix row by row to obtain the shard data sorting result corresponding to the data set.

9. The method according to claim 8, wherein the performing the inner product on the first matrix and the second matrix row by row to obtain the shard data sorting result corresponding to the data set further comprises:
multiplying the first shard matrix by the third shard matrix to obtain a first numerical value;
multiplying the first shard matrix by the fourth shard matrix to obtain a second numerical value;
multiplying the second shard matrix by the third shard matrix to obtain a third numerical value; and
adding the first numerical value, the second numerical value, and the third numerical value to obtain the shard data sorting result.

10. The method according to claim 9, wherein the sending the shard data sorting result to the target party further comprises:
generating a random number, and sending the random number and the shard data sorting result to the target party.

11. A data processing method, applied to a data owner party, wherein the method comprises:
obtaining a data set;
encoding each datum in the data set into multiple vectors;
splitting the multiple vectors into multiple shards of data; and
sending the multiple shards of data to a calculation party for performing: obtaining a first matrix according to the multiple shards of data, performing matrix operation on the first matrix to obtain a second matrix, obtaining a shard data sorting result corresponding to the data set according to the first matrix and the second matrix, and sending the shard data sorting result to a target party for determining a sorting result of data in the data set according to the shard data sorting result.

12. The method according to claim 11, wherein the encoding each datum in the data set into the multiple vectors further comprises:
determining a number of dimensions of the vector, wherein the number of dimensions is greater than or equal to a value of the datum;
encoding, according to the datum, an element at a position in the vector corresponding to the datum as a fourth numerical value;
encoding an element at a position other than the position corresponding to the datum in the vector as a fifth numerical value; and
obtaining the vector according to the fourth numerical value and the fifth numerical value.

13. The method according to claim 11, wherein the splitting the multiple vectors into the multiple shards of data further comprises:
for each vector of the multiple vectors, splitting the vector into multiple shard vectors such that a sum of the multiple shard vectors is equal to the vector; and
using the shard vector as the shard data.

14. An electronic device, comprising a memory, a processor, and a computer program stored in the memory and executable on the processor, wherein the processor, when executing the program, performs the data processing method comprising:
obtaining multiple shards of data of each datum in a data set, wherein the data set comes from a data owner party;
obtaining a first matrix according to the multiple shards of data;
performing matrix operation on the first matrix to obtain a second matrix;
obtaining a shard data sorting result corresponding to the data set according to the first matrix and the second matrix; and
sending the shard data sorting result to a target party for determining a sorting result of data in the data set according to the shard data sorting result.

15. The electronic device according to claim 14, wherein the multiple shards of data comprise multiple first shards of data and multiple second shards of data, the first matrix comprises a first shard matrix and a second shard matrix, and the obtaining the first matrix according to the multiple shards of data further comprises:
obtaining the first shard matrix according to the multiple first shards of data; and
obtaining the second shard matrix according to the multiple second shards of data.

16. The electronic device according to claim 15, wherein the second matrix comprises a third shard matrix and a fourth shard matrix, and the performing matrix operation on the first matrix to obtain a second matrix further comprises:
performing matrix operation on the first shard matrix to obtain the third shard matrix; and
performing matrix operation on the second shard matrix to obtain the fourth shard matrix.

17. The electronic device according to claim 16, wherein the obtaining a shard data sorting result corresponding to the data set according to the first matrix and the second matrix further comprises:
obtaining the shard data sorting result according to the first shard matrix, the second shard matrix, the third shard matrix, and the fourth shard matrix.

18. An electronic device, comprising a memory, a processor, and a computer program stored in the memory and executable on the processor, wherein the processor, when executing the program, performs the data processing method comprising:
obtaining a data set;
encoding each datum in the data set into multiple vectors;
splitting the multiple vectors into multiple shards of data; and
sending the multiple shards of data to a calculation party for performing: obtaining a first matrix according to the multiple shards of data, performing matrix operation on the first matrix to obtain a second matrix, obtaining a shard data sorting result corresponding to the data set according to the first matrix and the second matrix, and sending the shard data sorting result to a target party for determining a sorting result of data in the data set according to the shard data sorting result.

19. A non-transitory computer-readable storage medium, storing computer instructions, wherein the computer instructions are used to cause a computer to perform the method according to claim 1.

20. A non-transitory computer-readable storage medium, storing computer instructions, wherein the computer instructions are used to cause a computer to perform the method according to claim 11.
